(19) United States
(12) Patent Application Publication
(10) Pub. No.: US 2021/0113420 A1
(43) Pub. Date: Apr. 22, 2021

(54) Crutch Harness Apparatus

(71) Applicant: Thomas Chi, Seattle, WA (US)

(72) Inventor: Thomas Chi, Seattle, WA (US)

(21) Appl. No.: 17/125,363

(22) Filed: Dec. 17, 2020

Related U.S. Application Data
(63) Continuation of application No. 17/070,593, filed on Oct. 14, 2020.
(60) Provisional application No. 62/924,047, filed on Oct. 21, 2019.

(51) Int. Cl. A61H 3/02; A61H 3/00

(52) U.S. Cl. CPC A61H 3/02; A61H 3/008; A61H 2201/1652; A61H 2201/1633; A61H 2003/007

(57) ABSTRACT

An improved ambulatory crutch system is taught, permitting the user's body to be suspended by a seat-based harness apparatus rather than bearing the weight of their body on their hands and axillae. The improved crutch includes a seat-based harness, including a seat assembly, leg loops, and an optional belt. The harness supports the user's body under the ischial tuberosities.

### CROSS-REFERENCE TO RELATED APPLICATION

The present application claims the benefit of U.S. Provisional Patent App. No. 62/924,047, titled “CRUTCH HARNESS APPARATUS,” filed 21, Oct. 2019. The above application is incorporated by reference herein in its entirety.

### UTILITY PATENT APPLICATION

This specification relates generally to improvements to medical crutches to aid in the ambulation of patients with impaired mobility. More specifically, this specification relates to an apparatus for an improved medical ambulatory crutch system, and methods for use thereof.

People with leg injuries, or other mobility impairments, use crutches. Crutches are often uncomfortable to use, particularly for long periods of time. Crutch ambulation is exceedingly difficult and exhausting for most people. Even in physically fit individuals, all-day use of crutches invariably results in hand and axilla pain.

Many fractures and lower extremity surgeries mandate non-weightbearing or minimal weightbearing status for six weeks or more, and most patients do not tolerate this well. The configuration of commonly known crutches is designed to transfer the weight of the user through the hands, and palm pain is essentially ubiquitous. Most people end up using their axillae (armpits) to share the weight, and this causes pain, chafing, and compression of the brachial plexus nerves, resulting in pain, numbness, or even weakness in the arms. Specialty crutches (forearm crutches, platform crutches) still place weight through the hands or axillae. Elbow platform crutches are imbalanced, heavy, and unwieldy.

In the past, people have tried to improve on crutch technology, without success. For example, U.S. Pat. No. 5,348,035 HARNESS ASSEMBLY FOR A CRUTCH USER to Porter (“PORTER”) attempted to improve crutches with a swinging harness, but this attempt failed to be adopted. Specifically, PORTER's crutch assembly was flawed in that the connecting members from which the harness hung were in the front of the device, causing the user to fall over backwards. Additionally, PORTER appears to be based on a safety harness. The configuration of the straps or ropes in the safety harness causes pressure and pain where the straps come in contact with the user's body. PORTER is a standard-issue worker's safety harness with side attachments that does not work adequately and has not been commercially developed.

Accordingly, there remains a need for systems and methods to improve crutches for the benefit of patients.

### SUMMARY

In accordance with the foregoing objectives and others; methods, systems and apparatuses, including improved crutch devices with harnesses, are provided for increasing patient comfort and utility.

In some embodiments, apparatus are provided. The apparatus may include an ambulatory crutch apparatus comprising a pair of crutches, each crutch having a top portion, two vertical connecting members, a seat structure, and two leg loops, wherein each vertical connecting member is attached to the top portion of one of the pair of crutches, and also attached to a lateral portion of the seat structure, each of the two leg loops are attached to the seat structure, the seat structure maintains a separation between the leg loops, the leg loops enclose the leg below the anterior superior iliac spine.

The apparatus also may include one or more of a belt to be secured around the waist of the user, a buckle on each leg loop, a buckle on vertical connecting member(s), and/or a buckle on the belt.

In another embodiment, methods are provided. The methods may include a method for assisting an injured patient in ambulation, comprising providing to a patient a pair of crutches, each having a top portion, two vertical connecting members, a seat structure, and two leg loops, wherein each vertical connecting member is attached to the top portion of one of the pair of crutches, and also attached to a lateral portion of the seat structure, each of the two leg loops are attached to the seat structure, the seat structure maintains a separation between the leg loops, and the leg loops enclose the leg below the anterior superior iliac spine.

The methods also may include one or more of a belt to be secured around the waist of the user, a buckle on the leg loop(s), a buckle on the vertical connecting members, and/or a buckle on the belt.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a front view of a crutch seat assembly 10.

FIG. 2 shows a front view of a crutch seat assembly 10 in use by a person.

FIG. 3 shows a rear view of a crutch seat assembly 10 in use by a person.

FIG. 4 shows a side view of a crutch seat assembly 10 in use by a person.

FIG. 5 shows a three-quarters view of a crutch seat assembly 10 in use by a person.

### DETAILED DESCRIPTION

Various apparatus, methods and systems are disclosed to allow the manufacture and usage of improved crutch devices.

One goal of some embodiments of the inventions described herein is to alleviate pressure on the hands and axillae when using crutches by transferring weight to a pelvic harness.

In some embodiments, high-strength webbing is used to create a seat-based harness, providing support under the ischial tuberosities. In some embodiments, the device attaches to crutches. The device mimics the feeling of sitting in a chair or park swing. The device dramatically reduces weightbearing through the hands and axillae by transferring it to a pelvic support harness.

This device is designed to be used with crutches and is made to be comfortable despite being used continuously all day. While a sport harness (e.g. a climbing harness) transfers weight through the legs upwards and forwards to a central loop near the umbilicus; this device transfers weight from the ischial tuberosities to the side of the pelvis and directly upwards to crutches. A sport climbing harness can be uncomfortable, however, because weight transfer is through the posterior legs and to the front of the body. Additionally, such a device cannot be used with crutches safely in many circumstances, even if crutches are attached to the sides of it, because it would tend to cause the user's body to fall or rotate forward, causing injury.

One of several unique features of some embodiments of the device is the “seat.” Consider sitting on the edge of a countertop with the legs dangling over the side. The weight goes through the ischial tuberosities (the “sit bones”). The tendency of course is to slide forward and off the countertop. These embodiments mimic sitting on a countertop by causing the ischial tuberosities to bear the weight, but makes it comfortable and prevents the person from sliding off the support by optionally adding straps around the front of the legs.

A patent has previously been issued (U.S. Pat. No. 5,348,035) on Sep. 20, 1994 for a safety harness-based device. A “safety harness” is a device used by construction workers when the danger of falling from a height is high; typically high-rise workers, window washers, or outdoor maintenance workers. Such devices can be extensive, with shoulder suspenders, groin loops, belt support, and multiple attachment points available. It places weight to the loops in the back of the device when falling backwards, front loops when falling forward, and groin when falling downward. While some embodiments of the present invention could be constructed based on a safety-harness like device, it would not be comfortable and likely could not be worn all day without experiencing pain in the groin. In fact, workers who are required to use these safety harness and must spend any time suspended by them (e.g. window washers) complain that they are extremely uncomfortable if used for any length of time. Attaching a safety harness to crutches feels like being suspended by ropes looped just lateral to the genitalia; all the weight cuts through the perineal area. The perineum is not designed to take any weight in humans. One highly experienced commercial worker, when he saw how the instant device worked, recommended that it be placed inside of the mandatory commercial device so workers would actually use them.

Some embodiments of the present invention place weight not through the perineum, but rather through the “sit bones” or ischial tuberosities, the bones designed to bear a human's weight. A bicycle seat, park swing, or even a standard comfort stool analogously position the weight of the human body on the sit bones.) The leg loops are angled laterally rather than superiorly and attach under the anterior superior iliac spine (i.e., below the pelvic brim) rather than high above the belt line such as in prior devices. This creates an approximately 30-degree angled leg loop rather than the 75 degrees of a safety harness, so they become true leg loops rather than groin loops. The seat directs these leg loops laterally and lends support to the shape and structure of the device. It also creates space for the scrotum, which is painfully constricted in prior devices.

The seat may be an anatomical structure similar to a comfort bicycle seat but pre-contoured like a child's park swing. It may be trapezoidal in shape, with the wide part under the ischial tuberosities and the front part wide enough to direct the anterior leg loops away from the genitalia. Different sizes will be required based on body shape, but similar to a sport climbing harness, there will be a finite number needed as the leg loops will be adjustable.

Other seat embodiments are also part of the instant invention. These include seats made of webbing, cloth, heat molded ABS plastic or other plastics, wood, and others. An important characteristic is directed weightbearing. It is beneficial that weightbearing is directed to under the ischial tuberosities.

Webbing may be used for support. Webbing has been used extensively in safety and climbing harnesses and has proven to be strong and durable. In one embodiment, 2-inch webbing is used that threads through slots in the seat and is padded appropriately. Buckles are used to adjust the leg loop size, join the loops at the side, and attach to the crutches. The buckles allow for significant and easy adjustability. Most of these buckles are widespread and commercially available. The “three-way” attachment of the leg loops and crutch attachment is currently achieved with a commercially available resistance slider buckle, but a specialty buckle could be implemented instead.

Materials used in the construction of certain prototype embodiments include:
a. ⅛ inch ABS heat molded plastic 2 inch webbing
b. 2 inch side release buckles
c. 2 inch CAM buckles
d. 2 inch tri-glide buckles
e. ¼ inch neoprene padding

In some embodiments, the seat may be constructed from an ABS heat molded plastic frame and a foam such as that used in comfort bicycle seats.

In some embodiments, wherever buckles or connections are used, adjustable connections improve the ability of the user to adjust the device to fit his or her body. Low profile buckles are preferable.

In accordance with the foregoing objectives and others, methods, systems and apparatuses, including improved crutch devices with harnesses, are provided for increasing patient comfort and utility.

In some embodiments, apparatus are provided. Certain apparatus according to the invention are depicted in the enclosed drawings.

In other embodiments, prototype apparatus are provided and depicted in the photographs provided with provisional patent application 62/924,047, incorporated herein by reference.

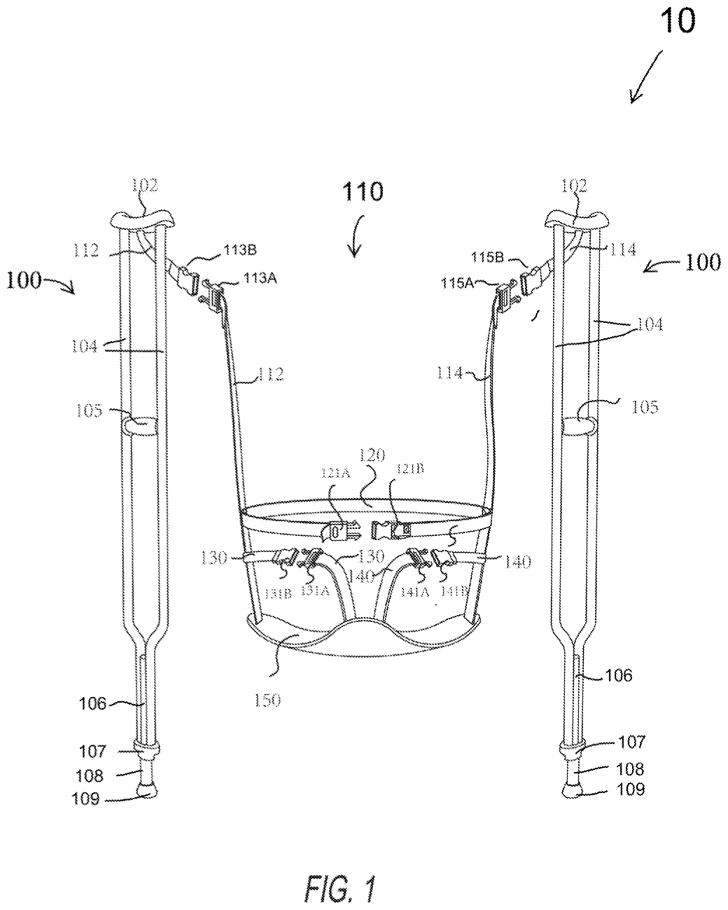

FIG. 1 depicts a front view of a crutch seat assembly 10, comprising a pair of crutches 100 and a seat-based harness 110. As shown in FIG.1, each of the crutches 100 has a top portion 102, two opposing shafts 104, a handgrip 105 extends between the two shafts 104, a middle tube 106 connected between the lower end of the shafts 104, a connector 107 receives the ends of the shafts 104 and the middle tube 106, a leg 108, and a crutch tip 109. The crutch tip 109 connects to the lower end of the leg 108 and provides a solid surface for improved stability and balance. The position of the handgrip 105 may be adjusted to fit the user's need. The seat-based harness 110 comprises a belt 120, two leg loops 130 and 140, a seat structure 150, and two vertical connecting members 112 and 114. The belt 120 includes a female buckle element 121A and a male buckle element 121B which allows for adjustment of the length of belt 120 to fit the user's waist as well as serving to lock/unlock the belt 120. The upper ends of the two vertical connecting members 112 and 114 are attached to the top portion 102 of each one of the pair of crutches 100, and also attached to a lateral portion of the seat structure 150 respectively. The vertical connecting member 112 includes a female buckle element 113A and a male buckle element 113B which allows the user to adjust the length of the vertical connecting member 112 to fit his or her body as well as serving to lock/unlock the vertical connecting member 112 from one of the crutches 100. The vertical connecting member 114 includes a female buckle element 115A and a male buckle element 115B which allows the user to adjust the length of the vertical connecting member 114 to fit his or her body as well as serving to lock/unlock the vertical connecting member 114 from one of the crutches 100. Each of the two leg loops 130 and 140 are attached to the seat structure 150 as well as the vertical connecting member 112 and 114 respectively. The seat structure 150 maintains a separation between the leg loops 130 and 140. The leg loop 130 includes a female buckle element 131A and a male buckle element 131B which allows the user to adjust the length of the leg loop 130 to fit his or her body as well as serving to lock/unlock the leg loop 130. The leg loop 140 includes a female buckle element 141A and a male buckle element 141B which allows the user to adjust the length of the leg loop 140 to fit his or her body as well as serving to lock/unlock the leg loop 140. The leg loops 130 and 140 enclose the leg below the anterior superior iliac spine.

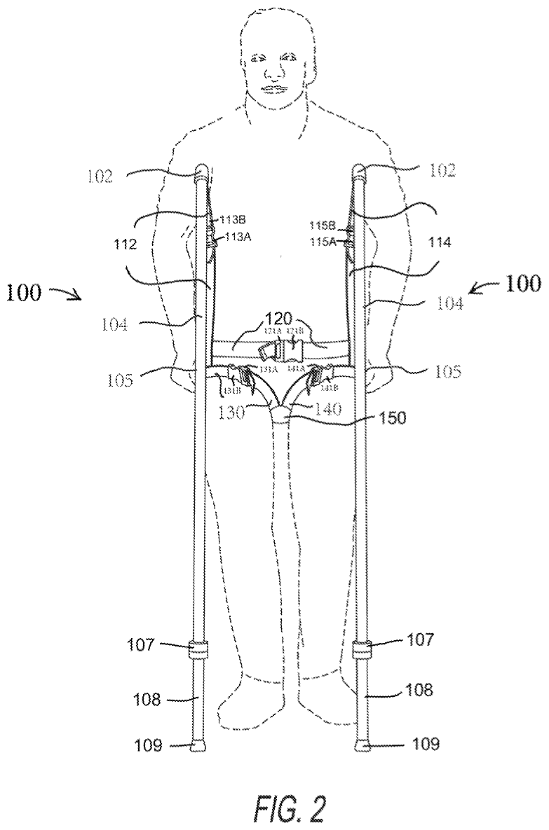

FIG. 2 depicts a front view of a crutch seat assembly 10 in use by a person. As shown in FIG. 2, when in use, a user secures the belt 120 around his or her waist by inserting the female buckle element 121A into the male buckle element 121B, and leg loops 130 and 140 around the upper portion of each leg by inserting the female buckle element 131A into the male buckle element 131B, and inserting the female buckle element 141A into the buckle element 141B, respectively. The length of the belt 120 can be adjusted by sliding the belt 120 through an adjustment cleat of the female buckle element 121A to make the loop smaller or larger so that the length of the belt 120 is adapted to the waist of the user. The length of the leg loops 130 and 140 can be adjusted by sliding the straps through an adjustment cleat of the female buckle elements 131A and 141A respectively to make the leg loops smaller or larger so that the leg loops 130 and 140 are adapted to the user's thigh size. The user also attaches the two vertical connecting members 112 and 114 to the top portion 102 of each of the pair of crutches 100 by inserting the female buckle members 113A into the male buckle element 113B, and inserting the female buckle members 115A into the male buckle element 115B. The user can adjust the length of the two vertical connecting members 112 and 114 by sliding the vertical connecting members 112 and 114 through adjustment cleats of the female buckle elements 113A and 115A respectively to fit his or her body. After the user secures the belt 120, the two leg loops 130 and 140, and the two vertical connecting members 112 and 114, the user now can walk on the crutches 100 by placing each of the crutches 100 under his or her axillae and placing his or her hands on the handgrip 105 to control the crutches 100.

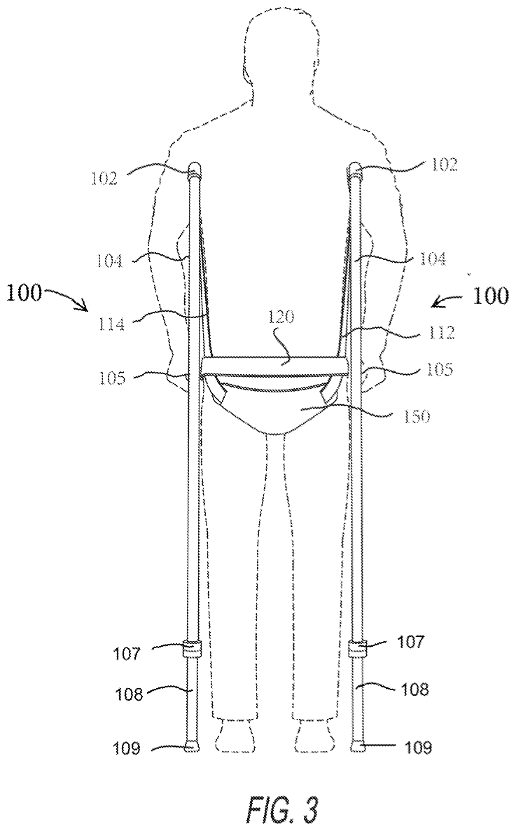

FIG. 3 depicts a rear view of a crutch seat assembly 10 in use by a person. As depicted, the two vertical connecting members 112 and 114 are attached to the seat structure 150. The length of the vertical connecting members 112 and 114 can be adjusted so that the seat 150 comfortably supports the user's weight.

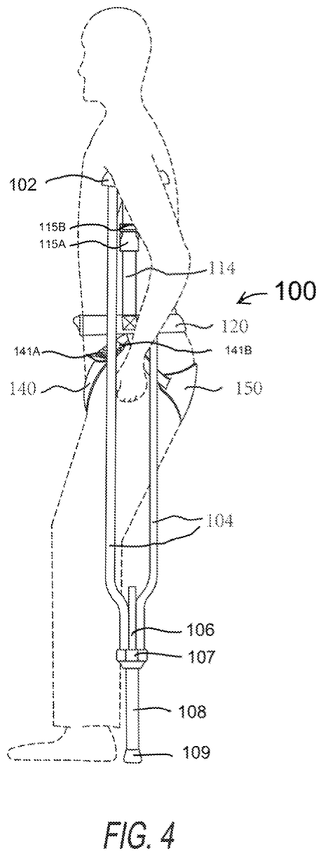

FIG. 4 depicts a side view of a crutch seat assembly 10 in use by a person. The user puts the top portion 102 under his or her axillae and holds the hand grip 105 to move the crutch 100.

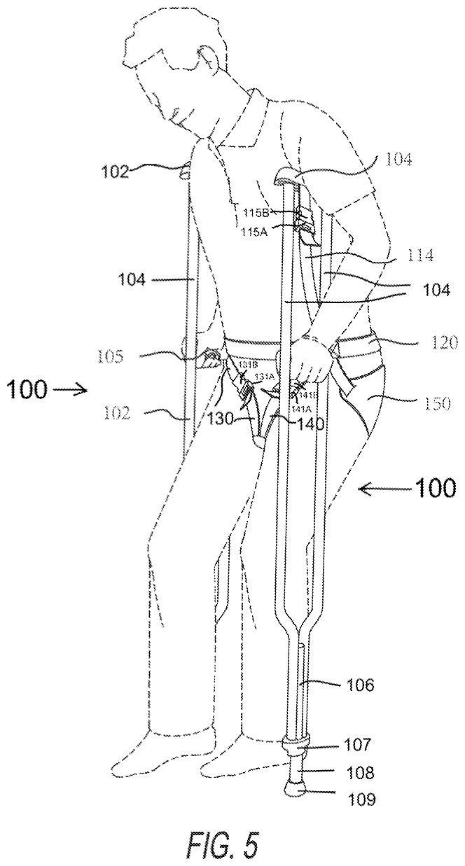

FIG. 5 depicts a three-quarters view of a crutch seat assembly 10 in use by a person. As can be seen from FIGS. 2-5, the user can alleviate pressure on the hands and axillae when using crutches by transferring weight to a pelvic harness.

Additional details of the inventions and additional embodiments thereof are also disclosed in the attached supplemental drawings, figures, presentations, invention disclosure, and other material.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification and the invention. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. An ambulatory crutch apparatus comprising:
a pair of crutches, each crutch having a top portion,
two vertical connecting members,
a seat structure, and
two leg loops, wherein:
each vertical connecting member is attached to the top portion of one of the pair of crutches, and also attached to a lateral portion of the seat structure,
each of the two leg loops are attached to the seat structure,
the seat structure maintains a separation between the leg loops,
the leg loops enclose the leg below the anterior superior iliac spine.

2. The ambulatory crutch apparatus of claim 1, wherein said ambulatory crutch apparatus comprising a belt to be secured around the waist of the user.

3. The ambulatory crutch apparatus of claim 1, wherein each of said leg loop includes a buckle.

4. The ambulatory crutch apparatus of claim 1, wherein each of said vertical connecting member includes a buckle.

5. The ambulatory crutch apparatus of claim 2, wherein said belt includes a buckle.

6. A method for assisting an injured patient in ambulation, comprising:
providing to a patient a pair of crutches, each having a top portion,
two vertical connecting members,
a seat structure, and
two leg loops, wherein:
each vertical connecting member is attached to the top portion of one of the pair of crutches,
also attached to a lateral portion of the seat structure,
each of the two leg loops are attached to the seat structure,
the seat structure maintains a separation between the leg loops,
the leg loops enclose the leg below the anterior superior iliac spine.

7. The method of claim 6, wherein said pair of ambulatory crutches having a belt to be secured around the waist of the user.

8. The method of claim 6, wherein each of said leg loop includes a buckle.

9. The method of claim 6, wherein each of said vertical connecting member includes a buckle.

10. The method of claim 7, wherein said belt includes a buckle.
